(19) United States
(12) Patent Application Publication
(10) Pub. No.: US 2018/0043762 A1
(43) Pub. Date: Feb. 15, 2018

(54) MODULAR VEHICLE COVER SYSTEM

(71) Applicant: Melvin Blanco, Valencia, CA (US)

(72) Inventor: Melvin Blanco, Valencia, CA (US)

(21) Appl. No.: 15/670,486

(22) Filed: Aug. 7, 2017

Related U.S. Application Data
(60) Provisional application No. 62/374,589, filed on Aug. 12, 2016.

(51) Int. Cl. B60J 11/06

(52) U.S. Cl. CPC B60J 11/06

(57) ABSTRACT

A modular vehicle cover system includes a vehicle cover assembly having a weather-proof vehicle cover defined a body configured to provide coverage for at least one window on a vehicle and a combination thereof, a plurality of magnet-fasteners about a perimeter of the body of the weather-proof vehicle cover for securing the weather-proof vehicle cover to the vehicle. The device provides an insulated protective barrier for a vehicle.

### CROSS REFERENCE TO RELATED APPLICATION

The present application is related to and claims priority to U.S. Provisional Patent Application No. 62/374,589 filed Aug. 12, 2016, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. Field of the Invention

The present invention relates generally to the field of vehicle covers and more specifically relates to a modular vehicle cover system.

### 2. Description of Related Art

When cars sit out in the sun, the temperature inside the vehicles can rise quickly, making it uncomfortable upon returning and possibly even causing some people to become sick. The interior surfaces, like the steering wheel and leather seats, may also be uncomfortable to the touch. Additionally, frost often develops on a vehicle's windshields in the winter, which can be time consuming and unpleasant to scrape off. Further, many people store valuable items in their cars, which are susceptible to theft if visible. Car covers are accessories that protect the vehicle from wear. They can help to maintain the resale value of the vehicle by protecting it from scuffs, scratches, property damage, and theft. A suitable covering solution is desired.

U.S. Pat. No. 4,972,892 to George C. Yeh relates to a vehicle cover and method of making same. The described vehicle cover and method of making same includes an all-seasons cover for enclosing the roof and windows of a passenger vehicle or the like. A flexible sheet of material, when laid out completely flat, defines a generally rectangular center section substantially conforming to the roof area; and front, rear and side sections foldable downward to cover the windows. The front margins of the side sections are indented to receive appendages of the side mirrors. The corners of adjacent sections overlap when installed on the vehicle, and fasteners fixed to the panels extend across the corners to secure the cover.

### BRIEF SUMMARY OF THE INVENTION

In view of the foregoing disadvantages inherent in the known vehicle covers art, the present disclosure provides a novel modular vehicle cover system. The general purpose of the present disclosure, which will be described subsequently in greater detail, is to provide a weather resistant cover for protecting an exterior and interior of a car.

A modular vehicle cover system is disclosed herein. The modular vehicle cover system includes a vehicle cover assembly having a weather-proof vehicle cover having a body configured to provide coverage for at least one window on a vehicle and a combination thereof, a plurality of magnet-fasteners about a perimeter of the body of the weather-proof vehicle cover for securing the weather-proof vehicle cover to the vehicle. Each of the plurality of magnet-fasteners may be positioned on a respective apex of a triangular flap-portion for attachment to the vehicle.

The weather-proof vehicle cover may comprise a plurality of magnet-fasteners for securing the device to a front and rear of a vehicle as well as a left and right side of the vehicle. The weather-proof vehicle cover may be configured to identify the vehicle. The weather-proof vehicle cover may be offered in a wide range of colors to accommodate user preference and to help users identify their parked vehicle in a crowded lot. The present invention protects an interior of the vehicle from the hot summer sun and an exterior of the vehicle from harsh snow and ice.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a modular vehicle cover system, constructed and operative according to the teachings of the present disclosure.

FIG. 1 is a perspective view of the modular vehicle cover system during an ‘in-use’ condition, according to an embodiment of the disclosure.

FIG. 2 is a perspective view of the modular vehicle cover system of FIG. 1, according to an embodiment of the present disclosure.

FIG. 3 is a perspective view of the modular vehicle cover system of FIG. 1, according to an embodiment of the present disclosure.

FIG. 4 is a perspective view of the modular vehicle cover system of FIG. 1, according to an embodiment of the present disclosure.

FIG. 5 is a perspective view of the modular vehicle cover system of FIG. 1, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to vehicle covers and more particularly to a modular vehicle cover system as used to improve the protection of vehicle surfaces.

Generally, the present invention protects a vehicle's interior from the hot summer sun and the exterior from harsh snow and ice. The device conceals valuables inside a vehicle from external view. This eliminates the need to ‘blast’ the air conditioning immediately upon entering a vehicle or hunt for a parking spot in the shade. It helps prevent exterior paint scratches and dings. The present invention reduces wear and tear on leather seats. The weather-proof vehicle cover quickly covers a vehicle, helping to maintain the internal temperature of the vehicle and prevent frost from forming on the windows.

The weather-proof vehicle cover may comprise a lightweight fabric or other suitable material for covering an exterior of a vehicle. The cover can be offered in small, medium, and large sizes and in varying amounts of coverage, including any combination of front and rear windshields and side windows. Fasteners may be spaced along the outer perimeter to help secure the cover to a vehicle's exterior. A suction cup may be attached in the middle of the product to hold it in place while being applied to the vehicle. The suction cup prevents the vehicle cover from moving before attaching the magnets to the vehicle. A strap may extend from one side of the weather-proof vehicle cover and can be rolled up in the vehicle's window to protect the weather-proof vehicle cover from theft. Additionally, the weather-proof vehicle cover can be offered in a wide range of colors to accommodate user preference and to help users identify their parked vehicle in a crowded lot.

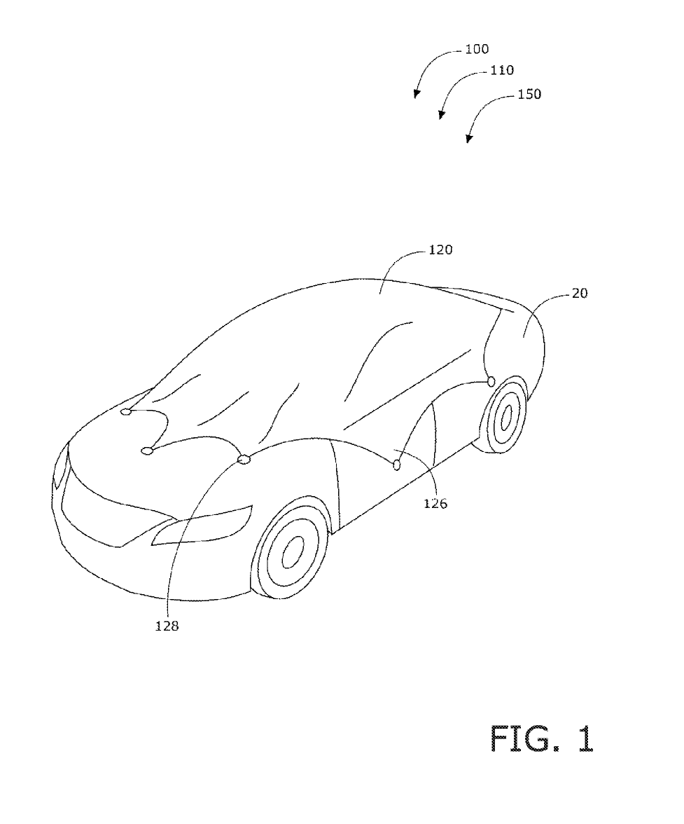

Referring now more specifically to the drawings by numerals of reference, there is shown in FIGS. 1-5, various views of a modular vehicle cover system 100. FIG. 1 shows a modular vehicle cover system 100 during an ‘in-use’ condition 150, according to an embodiment of the present disclosure. As illustrated, the modular vehicle cover system 100 may include a vehicle cover assembly 110 having a weather-proof vehicle cover 120 having a body 124 configured to provide coverage for at least one window 10 on a vehicle 20 and a combination thereof, a plurality of magnet-fasteners 128 about a perimeter of the body 124 of the weather-proof vehicle cover 120 for securing the weather-proof vehicle cover 120 to the vehicle 20. Each of the plurality of magnet-fasteners 128 may be positioned on a respective apex of a triangular flap-portion 126 for attachment to the vehicle 20.

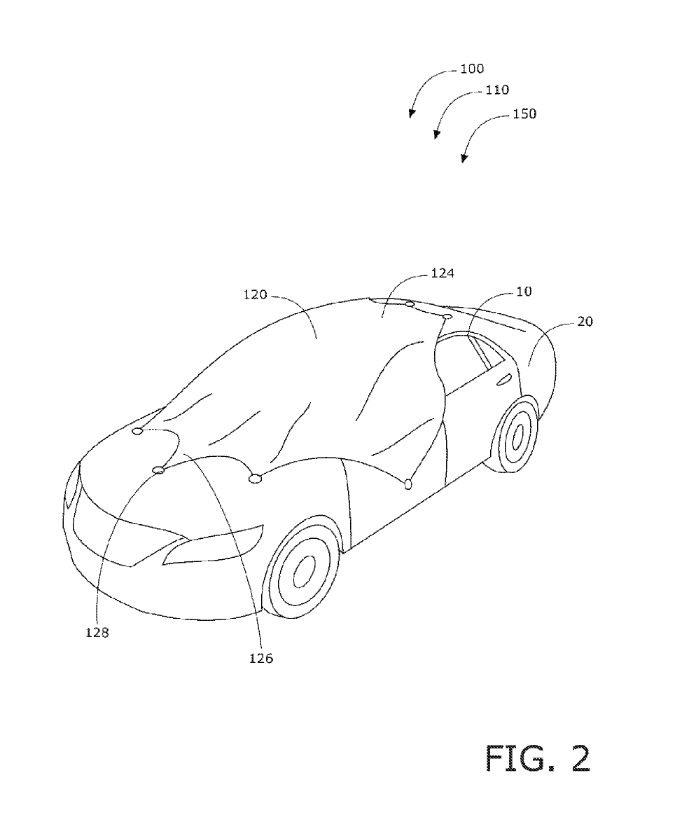

FIG. 2 shows a perspective view of the modular vehicle cover system 100 of FIG. 1, according to an embodiment of the present disclosure. As above, the modular vehicle cover system 100 may include the weather-proof vehicle cover 120 having a body 124 with a plurality of magnet-fasteners 128 about a perimeter of the body 124 of the weather-proof vehicle cover 120. The weather-proof vehicle cover 120 may further comprise a securing strap for securing the weather-proof vehicle cover 120 for securing during non-use. The weather-proof vehicle cover 120 restricts heat transfer and is configured to thermally insulate internal heat within the vehicle 20. The weather-proof vehicle cover 120 restricts heat transfer and is configured to thermally insulate internal cold the air within the vehicle 20. The weather-proof vehicle cover 120 is substantially planar and is configured to contour to a roof of the vehicle 20 and at least one window 10 on the vehicle 20.

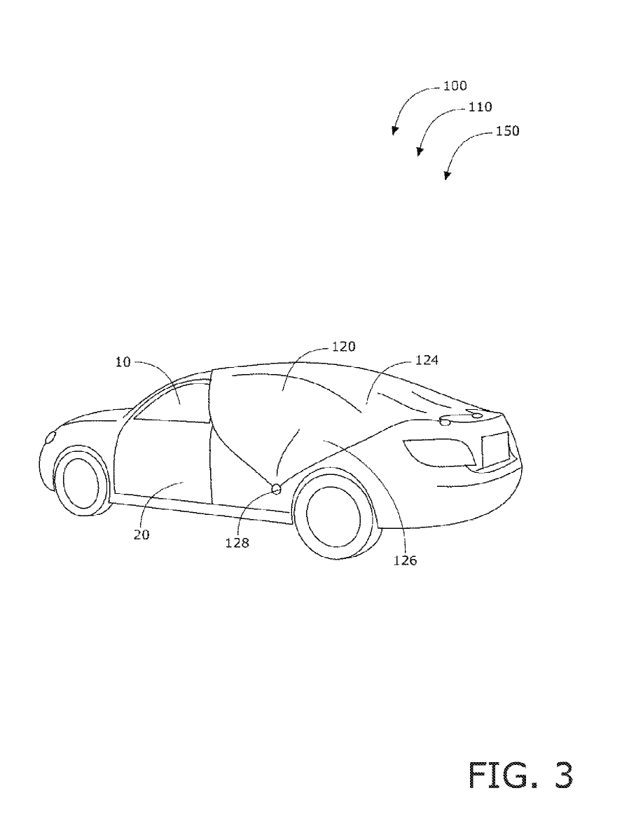

FIG. 3 shows a perspective view of the modular vehicle cover system 100 of FIG. 1, according to an embodiment of the present disclosure. As above, the modular vehicle cover system 100 may include the weather-proof vehicle cover 120. In a preferred embodiment, the plurality of magnet-fasteners 128 about the perimeter of the body 124 of the weather-proof vehicle cover 120 may be equidistantly spaced. The weather-proof vehicle cover 120 may comprise at least three of the plurality of magnet-fasteners 128 positioned on a respective apex of a respective the triangular flap-portion 126 for attachment to a front-portion of the vehicle and a rear-portion of the vehicle 20. The weather-proof vehicle cover 120 comprises at least one of the plurality of magnet-fasteners 128 positioned on a respective apex of a triangular flap-portion 126 for attachment on each side of the vehicle 20 for securing the weather-proof vehicle cover 120 to at least one door on each side of the vehicle 20. The front-portion of the vehicle 20 may comprise a hood of the vehicle 20 or a roof of the vehicle 20. The rear-portion of the vehicle 20 may comprise a trunk of the vehicle 20 or the roof of the vehicle 20.

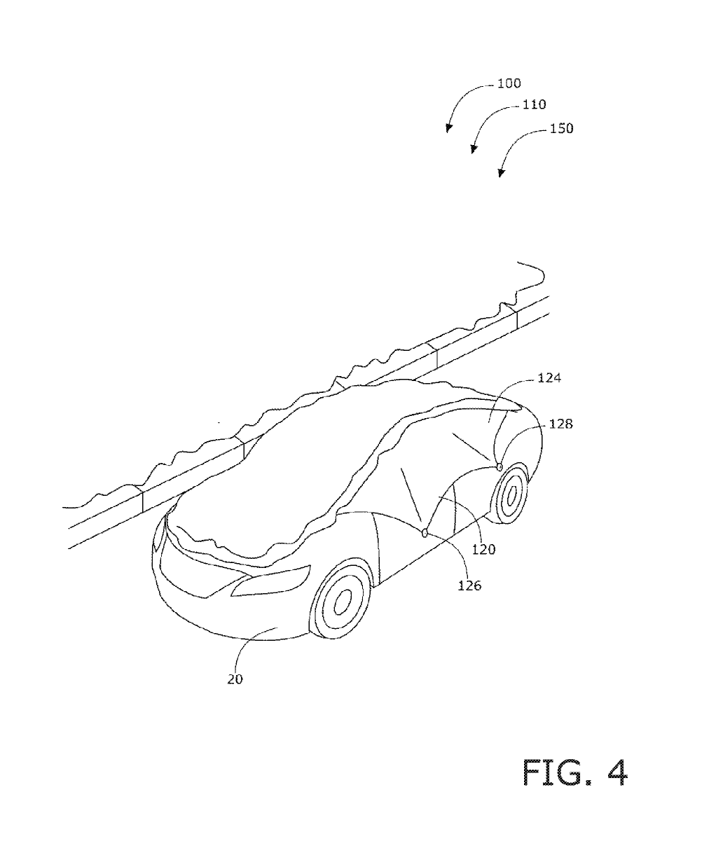

FIG. 4 shows a perspective view of the modular vehicle cover system 100 of FIG. 1, according to an embodiment of the present disclosure. As above, the modular vehicle cover system 100 may include the weather-proof vehicle cover 120. A first-weather-proof vehicle cover and a second-weather-proof vehicle cover may be configured to be used in combination to provide coverage for at least one window 10 on the vehicle 20. The body 124 of the weather-proof vehicle cover 120 is flexible. The weather-proof vehicle cover 120 may include eight of the plurality of magnet-fasteners 128 positioned on a respective apex of the triangular flap-portion 126 for firmly securing the device to the vehicle 20. The weather-proof vehicle cover 120 can be offered in small, medium, and large sizes and in varying amounts of coverage, including any combination of front and rear windshields and side windows.

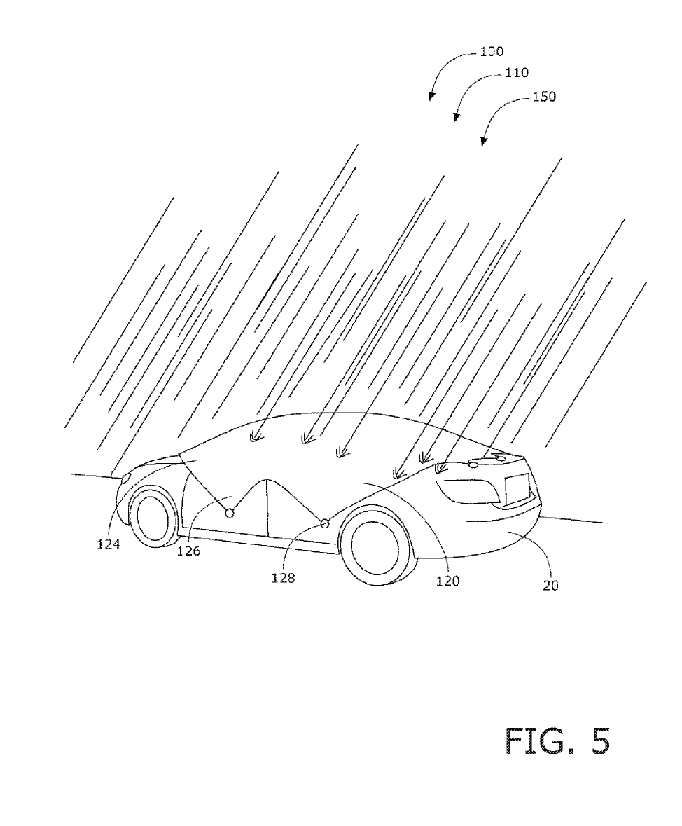

FIG. 5 shows a perspective view of the modular vehicle cover system 100 of FIG. 1, according to an embodiment of the present disclosure. As above, the modular vehicle cover system 100 may include the weather-proof vehicle cover 120. The weather-proof vehicle cover 120 may be configured to identify the vehicle 20. The weather-proof vehicle cover 120 may be offered in a wide range of colors to accommodate user preference and to help users identify their parked vehicle 20 in a crowded lot. The present invention protects an interior of the vehicle 20 from the hot summer sun and an exterior of the vehicle from harsh snow and ice.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

1. A modular vehicle cover system, the vehicle cover system comprising:
a vehicle cover assembly including;
a weather-proof vehicle cover having a body configured to provide coverage for at least one window on a vehicle and a combination thereof,
a plurality of magnet-fasteners about a perimeter of the body of the weather-proof vehicle cover and a suction fastener for securing the weather-proof vehicle cover to the vehicle; and
wherein each of the plurality of magnet-fasteners are positioned on a respective apex of a triangular flap-portion for attachment to the vehicle.

2. The modular vehicle cover system of claim 1, wherein the weather-proof vehicle cover further comprises a securing strap for securing the weather-proof vehicle cover for securing during non-use.

3. The modular vehicle cover system of claim 1, wherein the weather-proof vehicle cover restricts heat transfer and is configured to thermally insulate internal heat within said vehicle.

4. The modular vehicle cover system of claim 3, wherein the weather-proof vehicle cover restricts heat transfer and is configured to thermally insulate internal cold said air within said vehicle.

5. The modular vehicle cover system of claim 1, wherein the weather-proof vehicle cover is substantially planar and is configured to contour to a roof of the vehicle and at least one window on the vehicle.

6. The modular vehicle cover system of claim 1, wherein the plurality of magnet-fasteners about the perimeter of the body of the weather-proof vehicle cover are equidistantly spaced.

7. The modular vehicle cover system of claim 1, wherein the weather-proof vehicle cover comprises at least three of said plurality of magnet-fasteners positioned on a respective said apex of a respective said triangular flap-portion for attachment to a front-portion of the vehicle and a rear-portion of the vehicle.

8. The modular vehicle cover system of claim 7, wherein the weather-proof vehicle cover comprises at least one of said plurality of magnet-fasteners positioned on a respective apex of a triangular flap-portion for attachment on each side of the vehicle for securing the weather-proof vehicle cover to at least one door on each side of the vehicle.

9. The modular vehicle cover system of claim 1, wherein the front-portion of the vehicle comprises a hood of the vehicle.

10. The modular vehicle cover system of claim 1, wherein the front-portion of the vehicle comprises a roof of the vehicle.

11. The modular vehicle cover system of claim 1, wherein the rear-portion of the vehicle comprises a trunk of the vehicle.

12. The modular vehicle cover system of claim 1, wherein the rear-portion of the vehicle comprises a roof of the vehicle.

13. The modular vehicle cover system of claim 1, wherein a first-weather-proof vehicle cover and a second-weather-proof vehicle cover are configured to be used in combination to provide coverage for at least one window on said vehicle.

14. The modular vehicle cover system of claim 1, wherein the body of the weather-proof vehicle cover is flexible.

15. The modular vehicle cover system of claim 1, wherein the weather-proof vehicle cover comprises eight of said plurality of magnet-fasteners positioned on a respective said apex of said triangular flap-portion.

16. The modular vehicle cover system of claim 1, wherein the weather-proof vehicle cover is configured to identify the vehicle.

17. A modular vehicle cover system, the modular vehicle cover system comprising:
a vehicle cover assembly including;
a weather-proof vehicle cover having a body configured to provide coverage for at least one window on a vehicle and a combination thereof,
a plurality of magnet-fasteners about a perimeter of the body of the weather-proof vehicle cover and a suction fastener for securing the weather-proof vehicle cover to the vehicle;
wherein the weather-proof vehicle cover further comprises a securing strap for securing the weather-proof vehicle cover for securing during non-use;
wherein the weather-proof vehicle cover restricts heat transfer and is configured to thermally insulate internal heat within said vehicle;
wherein the weather-proof vehicle cover restricts heat transfer and is configured to thermally insulate internal cold said air within said vehicle;
wherein the weather-proof vehicle cover is substantially planar and is configured to contour to a roof of the vehicle and at least one window on the vehicle;
wherein the body of the weather-proof vehicle cover is flexible;
wherein the plurality of magnet-fasteners about the perimeter of the body of the weather-proof vehicle cover are equidistantly spaced;
wherein the weather-proof vehicle cover comprises at least three of said plurality of magnet-fasteners positioned on a respective said apex of a respective said triangular flap-portion for attachment to a front-portion of the vehicle and a rear-portion of the vehicle;
wherein the weather-proof vehicle cover comprises at least one of said plurality of magnet-fasteners positioned on a respective apex of a triangular flap-portion for attachment on each side of the vehicle for securing the weather-proof vehicle cover to at least one door on each side of the vehicle;
wherein the weather-proof vehicle cover comprises eight of said plurality of magnet-fasteners positioned on a respective said apex of said triangular flap-portion;
wherein the weather-proof vehicle cover is configured to identify the vehicle; and
wherein each of the plurality of magnet-fasteners are positioned on a respective apex of a triangular flap-portion for attachment to the vehicle to provide a weather-proof vehicle cover.
